(19) United States
(12) Patent Application Publication
(10) Pub. No.: US 2005/0235449 A1
(43) Pub. Date: Oct. 27, 2005

(54) Wipe-off grid

(76) Inventor: Manfred Kochler, Feuchtwangen (DE)

Correspondence Address: LERNER AND GREENBERG, PA, P O BOX 2480, HOLLYWOOD, FL, 33022-2480, US

(21) Appl. No.: 11/091,679

(22) Filed: Mar. 28, 2005

Related U.S. Application Data
(63) Continuation of application No. PCT/EP03/10629, filed on Sep. 24, 2003.

(30) Foreign Application Priority Data
Sep. 26, 2002 (DE) 102 45 190.7

(51) Int. Cl. B05C 21/00

(52) U.S. Cl. 15/257.06

(57) ABSTRACT

A wipe-off grid is provided for wiping and cleaning a paint roller. In order to produce a wipe-off grid for a paint roller, which ensures fast cleaning of the paint roller, a cleaning device is integrated and is embodied in the form of a scraping tray. In this manner, a paint roller can be quickly cleaned.

### CROSS-REFERENCE TO RELATED APPLICATION

This is a continuing application, under 35 U.S.C. §120, of copending international application No. PCT/EP2003/010629, filed Sep. 24, 2003, which designated the United States; this application also claims the priority, under 35 U.S.C. §119, of German patent application DE 102 45 190.7, filed Sep. 26, 2002; the prior applications are herewith incorporated by reference in their entirety.

### BACKGROUND OF THE INVENTION

Field of the Invention

The invention relates to a wipe-off grid for a paint roller.

The rolling part of a paint roller usually is formed of fibers which absorb paint during the painting or rolling operation. Therefore, very large quantities of paint still adhere to the paint roller even after the rolling part has been rolled along the surface to be painted. After use, the paint roller has to be thoroughly cleaned. This is usually done by hand under running water. The cleaning operation is very time-consuming, for example, it often takes a number of minutes for the residual paint to be completely washed out of the paint roller. Furthermore, the residual paint which is washed out pollutes the water used for cleaning.

Consequently, a large number of chemical substances pass into the sewage system. The paint which is washed out is lost and cannot be reused.

Paint roller wipers are known, for example see German utility patent DE 298 19 719 U1. It is also known to equip wipe-off grids with additional functions, for example for holding purposes, see German patent DE 42 35 120 C2.

### SUMMARY OF THE INVENTION

It is accordingly an object of the invention to provide a wipe-off grid for a paint roller that overcomes the above-mentioned disadvantages of the prior art devices of this general type, which ensures rapid cleaning of the paint roller.

With the foregoing and other objects in view there is provided, in accordance with the invention, a wipe-off grid for a paint roller. The wipe-off grid contains a grid element for wiping off excess paint, and an integrated wiper hollow for cleaning the paint roller.

According to the invention, in addition to a grid element for wiping off excess paint, the wipe-off grid also has a wiper hollow for cleaning the paint roller.

The basic idea of the invention relates to providing a wipe-off grid having an integrated cleaning device. The cleaning device is configured in the form of a hollow. In other words, the cleaning device contains a concavely curved formation. To be cleaned, the paint roller is simply pulled through the cleaning hollow, the radius of the hollow being configured to be such that both large rollers used for masonry paint and all paint rollers of smaller diameters can be cleaned.

The wiper hollow according to the invention enables the time required for cleaning to be reduced by more than half. Since additional washing of the paint roller can be significantly shortened or even avoided altogether, the water consumption is also considerably reduced. At the same time, there is less pollution to the waste water.

According to a particularly advantageous embodiment of the invention, the wiper hollow is disposed at the top part of the wipe-off grid, i.e. above the grid element. Since the wipe-off grid is usually positioned vertically in a paint can or pot, this configuration of the wiper hollow ensures that the majority of the paint which has been wiped out of the rolling part and has hitherto been washed out with the waste water runs back completely into the paint pot and can be reused. Arranging the wiper hollow integrally on the wipe-off grid also allows the paint roller to be cleaned without the need for an additional cleaning tool.

According to a further advantageous embodiment of the invention, the wiper hollow has a thin wiper edge. The wiper edge may, for example, be a few millimeters wide. The sharp-edged wiper element, which can be pressed into the fibers of the rolling part particularly successfully, allows the residual paint to be removed from the paint roller particularly efficiently. The wiper edge advantageously runs in the same plane as that in which the grid element is located. In other words, the paint roller which is to be cleaned can be pulled through the wiper hollow perpendicular to the plane of the grid element. The direction in which the paint roller is wiped through the cleaning hollow is of no importance to the degree of cleaning.

In addition to a handle, to allow clean and safe handling of the wipe-off grid, the top part of the wipe-off grid advantageously also contains a securing element for securing a paint roller to the wipe-off grid.

The securing element serves to temporarily hold the paint roller when work is briefly interrupted.

Conventional securing elements have the drawback that the rolling part secured to them is completely or partially immersed in the paint at least when the paint cans are completely full. This is disadvantageous on the one hand since a rolling part which is only partially immersed in the paint absorbs paint on one side, which results in that it does not roll in a balanced way on account of the uneven weight distribution. Uniform rolling is consequently no longer possible, which leads to the application of paint lacking quality. On the other hand, if the rolling part is completely immersed in the paint, the paint roller becomes too heavy. The paint which is applied to the surface to be painted smudges, which likewise leads to results of poor quality. The embodiment prevents the rolling part fitted to the securing element from being immersed in the paint, and consequently the drawbacks described above are eliminated. The securing element is disposed at least sufficiently far above the grid element for the rolling part of the paint roller to be located above the paint if some paint has already been removed from the paint can. However, it is preferable for the securing element to be disposed in such a way that the paint roller is not immersed in the paint even when the paint can is completely full. In this context, it is advantageous that the paint roller, in the event of work having to be interrupted, no longer has to be put down next to the paint can, for example on the floor or a window ledge, which under certain circumstances can cause paint spots. Rather, the paint roller can be held directly on the wipe-off grid.

The securing element is advantageously configured as a holding web for hanging the handle of the paint roller therefrom. The holding web is in this case preferably located in the plane of the grid element, so that the paint roller, in the secured state, bears reliably against the grid element by the longitudinal side of its rolling part. The holding web advantageously has holding lugs at both its ends, ensuring that the attached paint roller handle is reliably secured to the holding web and cannot slip off to the side.

If the securing element is disposed centrally on the wipe-off grid, a paint roller secured to it bears against the grid element over the entire width of the rolling part. The handle may then be disposed to the right-hand or left-hand side of the centrally positioned securing element. The wiper hollow is then advantageously disposed on the opposite side of the securing element from the handle. The integral top part produced in this way results in significantly improved handling of the wipe-off grid. The function of the securing element disposed centrally is not impaired by the laterally disposed handle. Rather, the grid can be held by the handle while the handle of the paint roller is attached to the holding web. The separate arrangement of the securing element and the grid handle allows the wipe-off grid to be handled using the handle at any time, even when a paint roller is attached to it.

According to a further advantageous configuration of the invention, the grid element has a corrugated wipe-off surface and/or is fluted. The corrugated or fluted configuration of the wipe-off surface in this case preferably runs in the longitudinal direction of the grid element, i.e. from the top downward in the wiping direction. In a further embodiment of the invention, the grid struts have a multiplicity of surface apertures.

Both the corrugated surface shape and the fluted configuration and the surface apertures prevent the rolling part from slipping off as it is rolled down the wipe-off grid. The corrugated and/or fluted wipe-off surface, as a result of a higher contact pressure, allows stronger engagement into the covering of the rolling part, preventing the paint roller from slipping off the wipe-off grid. The problems which have previously arisen when rolling the rolling part down the wipe-off grid on account of the rolling part not being held sufficiently securely as it is rolled down the grid and consequently only rotating to an insufficient extent, are thereby eliminated. After it has been rolled down the wipe-off grid three or four times, the rolling part is wetted with paint all the way around. The layer thickness of the paint applied and therefore the application of paint during painting becomes more uniform, so that one location of the surface to be painted only has to be rolled over once, rather than a number of times as has hitherto been the case. This leads to a considerable time saving.

At least the grid element, but preferably the entire wipe-off grid, is formed from plastic. This makes it possible to produce the wipe-off grid by an inexpensive injection-molding process. The preferably flat plastic top part of the wipe-off grid can in this case be used as a labeling surface for product information. Of course, it is also possible to use other materials or combinations of materials. For example, if a metal wire is used instead of a plastic to produce the wipe-off grid, it is possible for the wiper hollow, handle and/or securing element to be formed by correspondingly configured metal wires.

Other features which are considered as characteristic for the invention are set forth in the appended claims.

Although the invention is illustrated and described herein as embodied in a wipe-off grid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, plan view of a wipe-off grid according to the invention;

FIG. 2 is a diagrammatic, side view of the wipe-off grid according to the invention; and

FIG. 3 is a diagrammatic depiction of a wipe-off surface.

### DESCRIPTION OF THE PREFERRED EMBODIMENTS

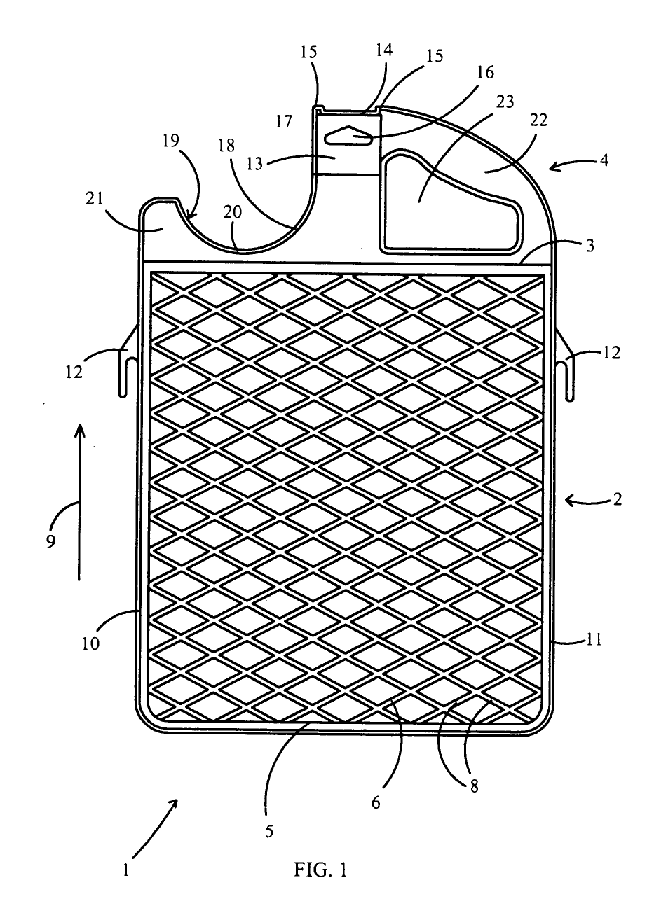

Referring now to the figures of the drawing in detail and first, particularly, to FIG. 1 thereof, there is shown a wipe-off grid 1 that substantially contains a rectangular grid element 2, one end side 3 of which is adjoined at the top by a top part 4. The grid element 2 has a frame 5, which surrounds a wipe-off surface 7 formed by a multiplicity of grid struts 6 which cross one another. The grid struts 6 have a multiplicity of surface apertures 8. The wipe-off surface 7 is fluted in a longitudinal direction 9 of the grid element 2. At its two longitudinal sides 10, 11, the frame 5 has in each case one holding hook 12. By the two holding hooks 12, the wipe-off grid 1 can be attached and fixed to the rim of the opening of a non-illustrated paint can or pot, with the frame 5 then bearing at least partially against the wall of the paint can.

The top part 4, which is formed integrally on the grid element 2, projects out of the paint can and has a holding web 13, disposed approximately centrally, for hanging a non-illustrated paint roller handle. The holding web 13 with a supporting edge 14, which is flanked by holding lugs 15 on both sides, also has a hanging opening 16, by which the wipe-off grid 1 can be held and stored in the unused state. The supporting edge 14 of the holding web 13 is at a sufficient distance from the grid element 2 for the rolling part of a paint roller suspended from it not to be immersed in the paint in the paint can or pot. Despite the unchanged configuration of the holding hooks 12 at the frame 5 of the wipe-off grid 1 compared to conventional wipe-off grids, and the resultant defined and unchanged position of the wipe-off grid 1 with respect to the paint can, the increase in the distance between the supporting edge 14 of the holding web 13 and the paint can ensures that the paint roller can be rested in a position in which it is kept clean.

The left-hand side edge 17, running in the grid element longitudinal direction 9, of the holding web 13 merges into a thin wiper edge 18 which, starting from the holding web 13, extends virtually as far as the left-hand longitudinal side 10 of the wipe-off grid 1. The wiper edge 18 describes a rounded section, resulting in a wiper hollow 19. The wiper hollow 19 runs from the holding web 13, describing an arc of 90°, to a low point 20 of the hollow, from where it merges, over a further arc of approximately 75°, into a side element 21 of the top part 4, which ends with the left-hand longitudinal side 10 of the wipe-off grid 1. If the rolling part of the paint roller is pulled through the wiper hollow 19, the paint which is pressed out runs back from the wiper edge 18 via the grid element 2 into the paint pot.

A handle 22, which likewise extends all the way to the right-hand longitudinal side 11 of the wipe-off grid 1, is formed integrally on the opposite side of the holding web 13 from the wiper hollow 19. The solid, flat top part 4 has a handle opening 23 to form the handle 22.

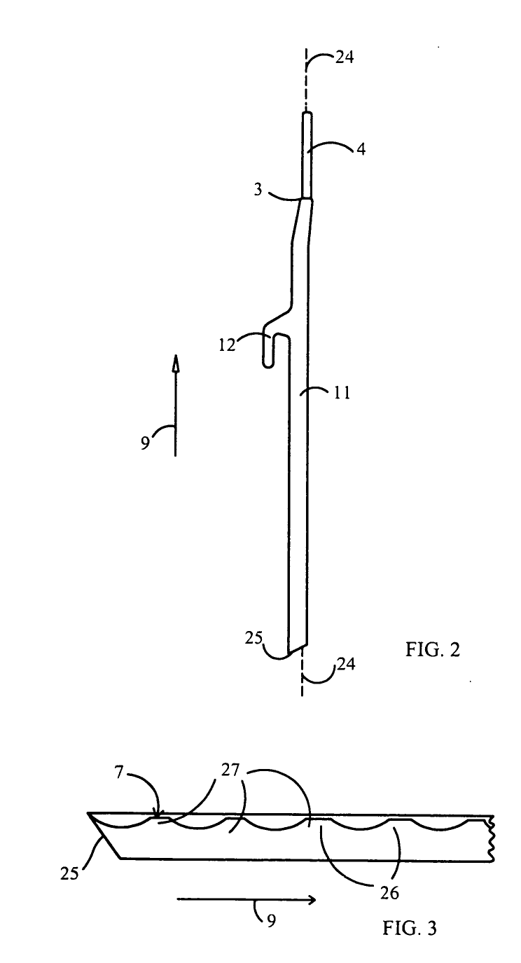

FIG. 2 illustrates a side view of the wipe-off grid 1. FIG. 2 clearly shows that the top part 4 with the wiper hollow 19 and the holding web 19 runs in a plane 24 of the grid element 2, indicated by a dashed line. This allows the securing of the paint roller to the wipe-off grid 1 and the cleaning of the rolling part in the wiper hollow 19 to be carried out in a particularly advantageous way.

FIG. 3 shows part of the wipe-off surface 7. The grid struts 6 are not straight, but rather are corrugated, resulting in a wipe-off surface 7 which is corrugated in form, with corrugation peaks and valleys. A multiplicity of wipe-off corrugations 26 are disposed between the upper end side 3 and lower end side 25 of the grid element 2. When the rolling part rolls along the grid element 2, in particular the parts 27 of the grid struts 6 which form the corrugation peaks engage in the fibers of the rolling part, allowing the residual paint to be forced out particularly efficiently.

1. A wipe-off grid for a paint roller, comprising:
a grid element for wiping off excess paint; and
an integrated wiper hollow for cleaning the paint roller.

2. The wipe-off grid according to claim 1, further comprising a top part, said wiper hollow is disposed above said grid element, on said top part.

3. The wipe-off grid according to claim 1, wherein said wiper hollow has a thin wiper edge.

4. The wipe-off grid according to claim 2, wherein said top part has a handle.

5. The wipe-off grid according to claim 2, wherein said top part has a securing element for the paint roller.

6. The wipe-off grid according to claim 5, wherein said securing element is disposed such that, when the wipe-off grid is disposed in a paint pot, a rolling part of the paint roller, supported by said securing element, is located above the paint in the paint pot.

7. The wipe-off grid according to claim 5, wherein said securing element has a web for hanging a paint roller handle thereon.

8. The wipe-off grid according to claim 1, wherein said grid element has a corrugated wipe-off surface.

9. The wipe-off grid according to claim 1, wherein said grid element has grid struts forming a wipe-off surface, said grid struts are fluted.

10. The wipe-off grid according to claim 9, wherein said grid struts have a multiplicity of surface apertures formed therein.

11. The wipe-off grid according to claim 1, wherein at least said grid element is formed from plastic.

12. The wipe-off grid according to claim 1, wherein the entire wipe-off grid is formed from plastic.
